(19) United States
(12) Patent Application Publication
(10) Pub. No.: US 2024/0289291 A1
(43) Pub. Date: Aug. 29, 2024

(54) MASTER/SLAVE SYSTEM CONFORMING TO I2C COMMUNICATION PROTOCOL

(71) Applicant: Raffar Technology Corp., Hsinchu County (TW)

(72) Inventors: Ying-Ze Liao, Hsinchu County (TW); Li-Hao Wang, Hsinchu County (TW); Chun-Chi Lin, Hsinchu County (TW)

(73) Assignee: Raffar Technology Corp., Hsinchu County (TW)

(21) Appl. No.: 18/144,533

(22) Filed: May 8, 2023

(30) Foreign Application Priority Data
Feb. 24, 2023 (TW) 112201725

(51) Int. Cl. G06F 13/362; G06F 13/42

(52) U.S. Cl. CPC G06F 13/362; G06F 13/4282; G06F 2213/0016

(57) ABSTRACT

A master/slave system conforming to an I2C communication protocol includes a master, an I2C bus, a power supply module, an independent slave and a plurality of dependent slaves. The master is configured to generate a data signal and a clock signal, the data signal including address information and a plurality of control instructions. The power supply module is configured to provide constant voltage power in a high potential state to the I2C bus. The independent slave is provided with a device address and is configured to receive the data signal and the clock signal according to the device address, the address information and the control instructions. The plurality of dependent slaves are connected in series with one another through a plurality of buses and are electrically connected to the independent slave, the potential state of each bus in idle is different from that of the I2C bus in idle.

### CROSS-REFERENCE TO RELATED APPLICATION

This non-provisional application claims priority under 35 U.S.C. § 119(a) to patent application Ser. No. 112201725 filed in Taiwan, R.O.C. on Feb. 24, 2023, the entire contents of which are hereby incorporated by reference.

### BACKGROUND

### Technical Field

The present disclosure relates to an I2C communication protocol, and particularly relates to a master/slave system including an I2C bus.

### Related Art

An I2C (Inter-Integrated Circuit) communication protocol is a hardware communication protocol, which is usually applied to a system having a master/slave model (hereinafter referred to as master/slave system). In a traditional master/slave system, a master is electrically connected to a plurality of slaves through buses conforming to the I2C communication protocol (hereinafter referred to as I2C bus). However, due to the upper limit of bit length in the I2C communication protocol, there can only be 128 devices on one I2C bus at most; and that is, on one I2C bus, one master can control only 127 slaves at most.

In addition, the I2C bus can be normally used only when being in a high potential state. Therefore, in practice, the I2C bus can be electrically connected to the master and the slave only in a parallel mode to avoid the master/slave system from generating high power consumption. Under such limiting condition, the I2C bus cannot be effectively applied to products in some fields, such as LED strips or LED panels having a plurality of driving circuits connected in series with one another.

### SUMMARY

In order to solve the problem above, the present disclosure provides a master/slave system conforming to an I2C communication protocol. The master/slave system includes a master, configured to generate a data signal and a clock signal, the data signal including address information and a plurality of control instructions; an I2C bus, electrically connected to the master and including a data line configured to transmit the data signal, and a clock line configured to transmit the clock signal; a power supply module, electrically connected to the I2C bus and configured to provide constant voltage power to the I2C bus, the constant voltage power is in a high potential state; an independent slave, electrically connected to the I2C bus, provided with a device address and configured to receive the data signal and the clock signal according to the device address and the address information, and a plurality of dependent slaves, connected in series with one another through a plurality of buses and electrically connected to the independent slave, the potential state of each bus in idle is different from that of the I2C bus in idle.

In some embodiments, the power supply module includes a first resistor, one end of which is electrically connected to the constant voltage power and the other end is electrically connected to the data line, the first resistor is configured to pull up the potential of the data line to reach the potential of the constant voltage power supply; and a second resistor, one end of which is electrically connected to the constant voltage power and the other end is electrically connected to the clock line, the second resistor is configured to pull up the potential of the clock line to reach the potential of the constant voltage power supply.

In some embodiments, the plurality of buses are of a double-wire structure (2-wire), and each bus is configured to transmit the data signal and the clock signal; each dependent slave is configured to receive the data signal and the clock signal; and at least one wire of each bus is in a low potential state when being idle.

In some embodiments, the plurality of buses are of a single-wire structure (1-wire), and each bus is configured to transmit the data signal; each dependent slave is configured to receive the data signal; and each bus is in a low potential state when being idle.

In some embodiments, the independent slave is further configured to generate a driving signal of the independent slave according to each corresponding control instruction; and each dependent slave is further configured to generate a driving signal of each dependent slave according to each corresponding control instruction.

In some embodiments, the master/slave system further includes a plurality of light-emitting circuits, and each light-emitting circuit is electrically connected to the independent slave or the corresponding dependent slave.

In some embodiments, the master/slave system further includes a plurality of switching circuits, and each switching circuit is electrically connected to the independent slave or the corresponding dependent slave.

In some embodiments, the master/slave system further includes a plurality of motors, and each motor is electrically connected to the independent slave or the corresponding dependent slave.

In some embodiments, the driving signal of the independent slave and the driving signal of each dependent slave are pulse width modulation (PWM) signals.

In some embodiments, the driving signal of the independent slave and the driving signal of each dependent slave are pulse amplitude modulation (PAM) signals.

In conclusion, according to some embodiments, the plurality of slaves connected in series with one another are electrically connected to the I2C bus of the master/slave system to increase the quantity of the slaves which can be controlled by the master. Therefore, even if there can only be 128 device on one I2C bus at most, the master system can control more than 127 slaves, expanding the application field of the master/slave system.

### BRIEF DESCRIPTION OF THE DRAWINGS

FIG. 1 is a module block diagram of a master/slave system according to a first embodiment.

FIG. 2 is a circuit schematic diagram of a first embodiment of the master/slave system in FIG. 1.

FIG. 3 is a time sequence diagram of an I2C bus according to some embodiments.

FIG. 4 is a schematic diagram of a data signal according to some embodiments.

FIG. 5 is a circuit schematic diagram of a second embodiment of the master/slave system in FIG. 1.

FIG. 6 is a module block diagram of a master/slave system according to a second embodiment.

FIG. 7 is a module block diagram of a master/slave system according to a third embodiment.

FIG. 8 is a module block diagram of a master/slave system according to a fourth embodiment.

FIG. 9 is a schematic diagram of a driving signal according to a first embodiment.

FIG. 10 is a schematic diagram of a driving signal according to a second embodiment.

### DETAILED DESCRIPTION

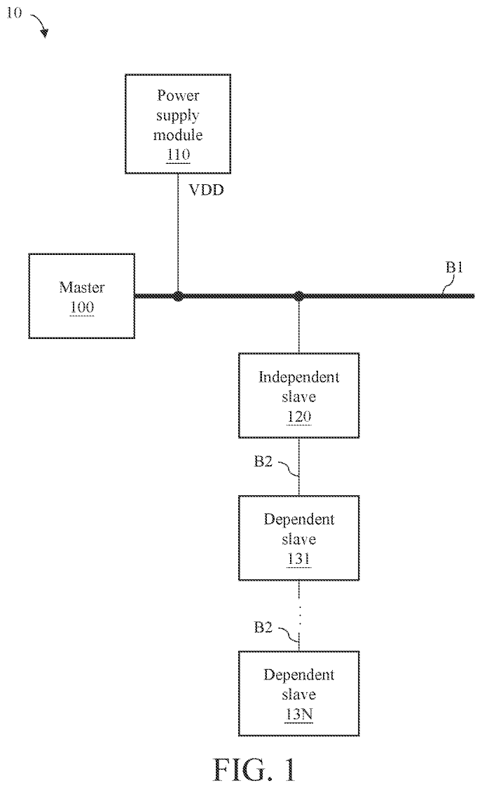

Refer to FIG. 1, FIG. 1 is a module block diagram of a master/slave system 10 according to a first embodiment. The master/slave system 10 includes a master 100, an I2C bus B1, a power supply module 110, an independent slave 120, and a plurality of dependent slaves 131-13N (N being a positive integer) which are connected in series with one another. The I2C bus B1 is electrically connected to the master 100, and the power supply module 110 is electrically connected to the I2C bus B1. The independent slave 120 is electrically connected to the I2C bus B1, and the plurality of dependent slaves 131-13N are electrically connected to the independent slave 120. The structures and functions of the master 100, the I2C bus B1, the power supply module 110, the independent slave 120 and the plurality of dependent slaves 131-13N are explained below respectively.

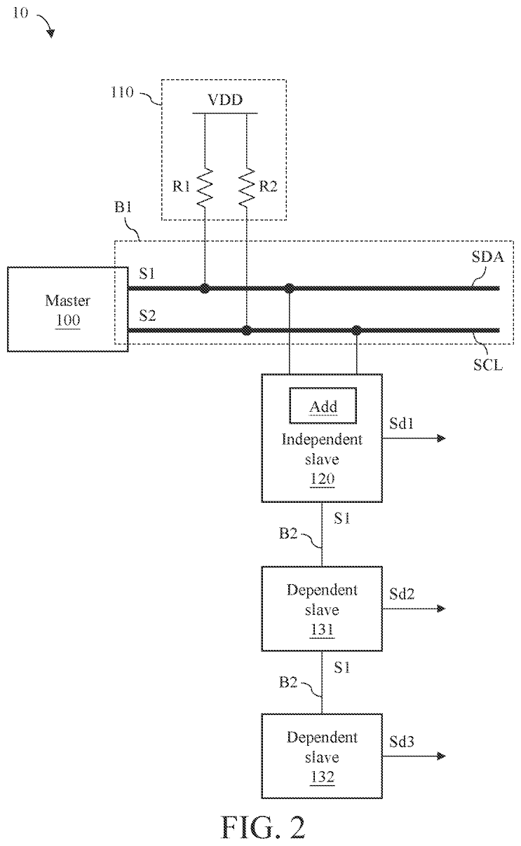

Refer to FIG. 2, FIG. 2 is a circuit schematic diagram of a first embodiment of the master/slave system 10 in FIG. 1. The master 100 is configured to generate a data signal S1 and a clock signal S2. In some embodiments, the master 100 may be a logic circuit or a control circuit, such as but not limited to a central processing unit (CPU), a system on chip (SoC), a microprocessor unit (MCU), a field programmable gate array (FPGA) or a complex programmable logic device (CPLD).

Refer to FIG. 2, the I2C bus B1 is a sequence communication bus conforming to an I2C communication protocol. The I2C bus B1 includes a data line SDA and a clock line SCL. The data line SDA is configured to transmit the data signal S1, and the clock line SCL is configured to transmit the clock signal S2. That is, the I2C bus B1 adopts a dual-wire structure (2-wire) to transmit signals.

Refer to FIG. 2, the power supply module 110 is configured to provide constant voltage power VDD to the I2C bus B1. The constant voltage power VDD is in a high potential state. In some embodiments, the potential of the high potential state is, for example, 1.8 V, 3.3 V or 5 V. The present disclosure is not limited thereto. According to the I2C communication protocol, the I2C bus B1 can normally run to transmit the signals only by maintaining the high potential state. Therefore, the master/slave system 10 provides the constant voltage power VDD in the high potential state to the I2C bus B1 through the power supply module 110, and then the data line SDA and the clock line SCL of the I2C bus B1 maintain the high potential state when being idle.

In some embodiments, the power supply module 110 includes a first resistor R1 and a second resistor R2. One end of the first resistor R1 is electrically connected to the constant voltage power VDD, and the other end of the first resistor R1 is electrically connected to the data line SDA. One end of the second resistor R2 is electrically connected to the constant voltage power VDD, and the other end of the second resistor R2 is electrically connected to the clock line SCL. In some embodiments, the first resistor R1 is configured to pull up the potential of the data line SDA to reach the potential of the constant voltage power VDD, and the second resistor R2 is configured to pull up the potential of the clock line SCL to reach the potential of the constant voltage power VDD. In some embodiments, the resistance value of the first resistor R1 and the resistance value of the second resistor R2 are, for example, 1.5 kiloohms, 2.2 kiloohms or 4.7 kiloohms. The present disclosure is not limited thereto.

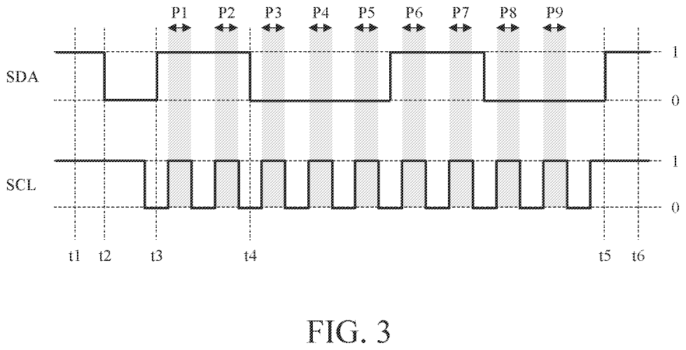

Refer to FIG. 3, FIG. 3 is a time sequence diagram of an I2C bus B1 according to some embodiments. The time sequence diagram of the I2C bus B1 is used to describe the operation principle of the I2C bus B1. As shown at a time point t1, when the data line SDA and the clock line SCL are both in the high potential state representing 1, it means that the master 100 is in an idle state, and at the moment, no signal is transmitted on the I2C bus B1. As shown at a time point t2, when the clock line SCL is in the high potential state, and if the data line SDA is converted from the high potential state to a low potential state representing 0, it means that the master 100 is started to transmit the data signal S1 and the clock signal S2.

As shown at a time point t3, when the clock line SCL is in the low potential state, the data line SDA can convert its potential state. That is, the data signal S1 is converted from the low potential state to the high potential state at the moment. As shown at a time period P1 and a time period P2, when the clock line SCL is in the high potential state, the data line SDA maintains its potential stat. That is, the data signal S1 maintains the high potential state at the moment.

As shown at a time point t4, when the clock line SCL is in the low potential state, the data line SDA can convert its potential state. That is, the data signal S1 is converted from the high potential state to the low potential state at the moment. As shown at time periods P3-P5, when the clock line SCL is in the high potential state, the data line SDA maintains its potential state. That is, the data signal S1 maintains the low potential state at the moment.

As shown at a time point t5, when the clock line SCL is in the high potential state, and if the data line SDA is converted from the low potential state to the high potential state, it means that the master 100 stops transmitting the data signal S1 and the clock signal S2 and finishes running. As shown at a time point t6, the data line SDA and the clock line SCL are both in the high potential state, so that the I2C bus B1 returns to the idle state, and at the moment, no signal is transmitted on the I2C bus B1.

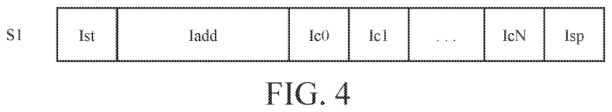

Refer to FIG. 3 and FIG. 4, FIG. 4 is a schematic diagram of a data signal S1 according to some embodiments. In some embodiments, the data signal S1 includes a start instruction Ist, address information Iadd, a plurality of control instructions Ic0-IcN (N being a positive integer) and a stop instruction Isp. In some embodiments, the start instruction Ist is used for indicating that the master 100 starts to transmit the data signal S1 and the clock signal S2 (as shown at the time point t2 in FIG. 3). In some embodiments, the stop instruction Isp is used for indicating that the master 100 stops transmitting the data signal S1 and the clock signal S2 (as shown at the time point t5 in FIG. 3).

In some embodiments, the address information Iadd is used for indicating an address of the slave to be controlled by the master 100. That is, in the master/slave system 10, the master 100 searches the address of the slave to be controlled on the I2C bus B1 through the address information Iadd. According to the I2C communication protocol, the bit length of the address information Iadd is 7 bits.

Refer to FIG. 2, the independent slave 120 is provided with a device address Add and is configured to receive the data signal S1 and the clock signal S2 according to the device address Add and the address information Iadd. When the device address Add of the independent slave 120 is matched with the address information Iadd of the data signal S1, the independent slave 120 can receive the data signal S1 and the clock signal S2. For example, when the device address Add and the address information Iadd are both [0100101], it means that the device address Add and the address information Iadd are matched, and the independent slave 120 can receive the data signal S1 and the clock signal S2 at the moment.

Refer to FIG. 3, in some embodiments, the I2C bus B1 transmits a 9-bit signal each time. The potential state of the data line SDA in each of the time periods P1-P9 corresponds to a 1-bit signal respectively. Taking the data line SDA in FIG. 3 as an example, the potential state of the data line SDA in the time periods P1-P9 is [110001100], so the data signal S1 transmitted by the I2C bus B1 is [110001100]. In some embodiments, the potential state of the data line SDA in the time periods P1-P8 corresponds to an instruction (including address information Iadd and a plurality of control instructions Ic0-IcN) in the data signal S1, and the potential state of the data line SDA in the time period P9 corresponds to a response signal (Ack) of the independent slave 120. When the response signal is the low potential state, it means that the independent slave 120 successfully receives the data signal S1 and the clock signal S2, and the master 100 can continuously transmit the signal to the independent slave 120 at the moment. When the response signal is the high potential state, it means that the independent slave 120 does not successfully receive the data signal S1 and the clock signal S2, and an error occurs, and the master 100 stops transmitting the signal to the independent slave 120 at the moment.

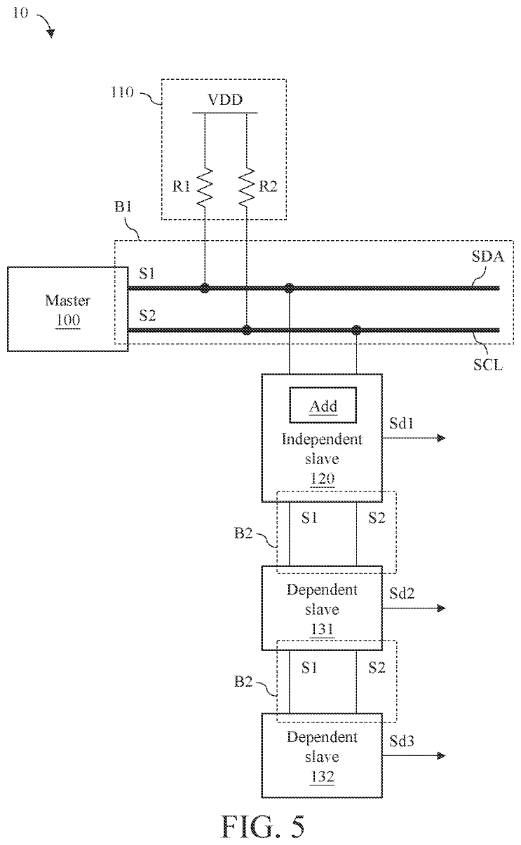

Refer to FIG. 2 and FIG. 5, FIG. 5 is a circuit schematic diagram of a second embodiment of a master/slave system 10 in FIG. 1. The plurality of dependent slaves 131 and 132 are connected in series with one another through a plurality of buses B2 and are electrically connected to the independent slave 120. In some embodiments, the plurality of buses B2 may be of a single-wire structure (1-wire) or a double-wire structure. The present disclosure is not limited thereto. Taking FIG. 2 as an example, when the plurality of buses B2 are of the single-wire structure, each bus B2 is configured to transmit the data signal S1, and each of the dependent slaves 131 and 132 is configured to receive the data signal S1. Taking FIG. 5 as an example, when the plurality of buses B2 are of the double-wire structure, each bus B2 is configured to transmit the data signal S1 and the clock signal S2, and each of the dependent slaves 131 and 132 is configured to receive the data signal S1 and the clock signal S2.

The potential state of the plurality of buses B2 in idle is different from the potential state of the I2C bus B1 in idle. The I2C bus B1 is in the high potential state when being idle. Therefore, in some embodiments, when the plurality of buses B2 are of the single-wire structure, each bus B2 is in the low potential state when being idle. In some embodiments, when the plurality of buses B2 are of the double-wire structure, at least one wire of each bus B2 is in the low potential state when being idle.

The functions of the plurality of buses B2 and the plurality of dependent slaves 131 and 132 in each embodiment will be illustrated below by taking the single-wire structure an example.

In some embodiments, the master 100 controls the independent slave 120 and the plurality of dependent slaves 131-13N through the plurality of control instructions Ic0-IcN respectively. FIG. 2 and FIG. 4 are taken as examples to describe the flow of the data signal S1 transmitted among the slaves. Refer to FIG. 2, in this embodiment, the master 100 needs to control three slaves (including the independent slave 120 and the dependent slaves 131 and 132), so that the data signal S1 transmitted by the master 100 includes the control instructions Ic0-Ic2 (N=2 in FIG. 4).

In some embodiments, when the independent slave 120 receives the data signal S1 and the clock signal S2 according to the device address Add and address information Iadd, the independent slave 120 receives the address information Iadd in the data signal S1 and the corresponding control instruction Ic0. Then, the independent slave 120 transmits the remaining instructions (including the control instructions Ic1 and Ic2) in the data signal S1 to the dependent slave 131 through one bus B2. Finally, the dependent slave 131 receives the control instruction Ic1 in the data signal S1 and transmits the remaining instructions (including the control instruction Ic2) in the data signal S1 to the dependent slave 132 through another bus B2, so that complete transmission of the control instructions Ic0-Ic2 is realized. That is, in this embodiment, the independent slave 120 receives the control instruction Ic0, the dependent slave 131 receives the control instruction Ic1, and the dependent slave 132 receives the control instruction Ic2.

In other embodiments, when the independent slave 120 receives the data signal S1 and the clock signal S2 according to the device address Add and address information Iadd, the independent slave 120 receives the address information Iadd in the data signal S1. Then, the independent slave 120 transmits the control instruction Ic0 in the data signal S1 to the dependent slave 132 through the plurality of buses B2, and transmits the control instruction Ic1 in the data signal S1 to the dependent slave 131. Finally, the independent slave 120 receives the control instruction Ic2, and therefore complete transmission of the control instructions Ic0-Ic2 is realized. That is, in this embodiment, the independent slave 120 receives the control instruction Ic2, the dependent slave 131 receives the control instruction Ic1, and the dependent slave 132 receives the control instruction Ic0.

In some embodiments, the independent slave 120 is addressed to serve as a basis for the master 100 to control the plurality of dependent slaves 131-13N. That is, as long as the master 100 obtains the device address Add of the independent slave 120 electrically connected to the plurality of dependent slaves 131-13N, the master device 100 can transmit the data signal S1 through the I2C bus B1, the independent slave 120 and the plurality of buses B2, and then control the plurality of dependent slaves 131-13N. At the moment, the master 100 transmits the data signal S1 and the clock signal S2 to the independent slave 120, and the data signal S1 is transmitted between the independent slave 120 and the plurality of dependent slaves 131-13N through the plurality of buses B2.

It should be noted that each bus B2 is in the low potential state when being idle. The potential of the low potential state is 0 V or 0.1 V. The present disclosure is not limited thereto. Since the independent slave 120 is addressed, the dependent slaves 131 and 132 do not need to receive the address information Iadd in the data signal S1. Therefore, the plurality of buses B2 can run normally to transmit the control instructions Ic0-IcN in the data signal S1 without conforming to the I2C communication protocol. That is, the plurality of buses B2 do not need to maintain the high potential state through the power supply module 110 when being idle, and only need to maintain the low potential state.

In some embodiments, the independent slave 120 and the plurality of dependent slaves 131-13N are the same devices. The devices may be driving circuits, processing circuits, logic circuits or control circuits, including but not limited to a pulse width modulation (PWM) circuit, a pulse amplitude modulation (PAM) circuit, a central processing unit (CPU), a system on chip (SoC), a microprocessor unit (MCU), a field programmable gate array (FPGA) or a complex programmable logic device (CPLD). That is, in some embodiments, the independent slave 120 and the dependent slaves 131-13N have the same functions and hardware structures.

Refer to FIG. 2, the functions of the independent slave 120 and the dependent slaves 131-132 will be illustrated below by taking the driving circuit as an example. In some embodiments, the independent slave 120 is further configured to generate a driving signal Sd1 of the independent slave 120 according to the corresponding control instruction Ic0, the dependent slave 131 is further configured to generate a driving signal Sd2 of the dependent slave 131 according to the corresponding control instruction Ic1, and the dependent slave 132 is further configured to generate a driving signal Sd3 of the dependent slave 132 according to the corresponding control instruction Ic2.

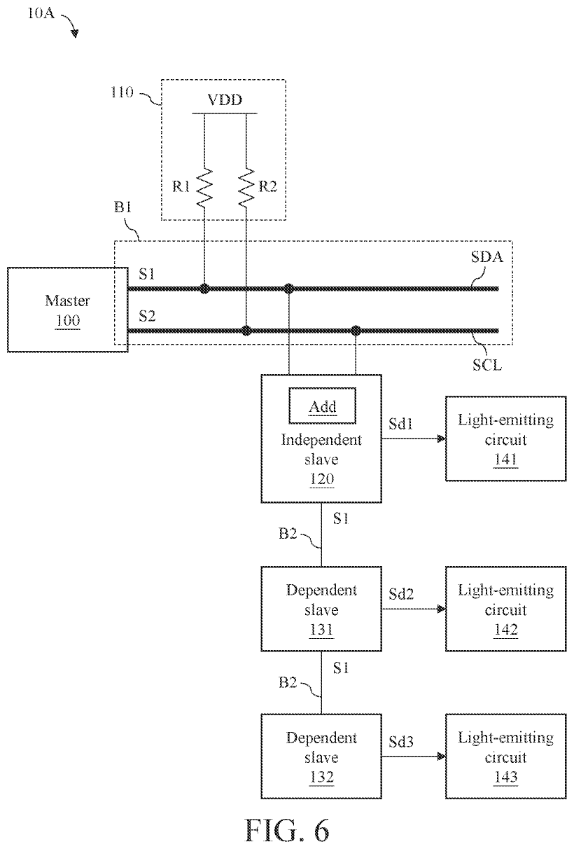

Refer to FIG. 2 and FIG. 6, FIG. 6 is a module block diagram of a master/slave system 10A according to a second embodiment. The master/slave system 10A corresponds to the master/slave system 10 in FIG. 2. In some embodiments, the master/slave system 10A further includes a plurality of light-emitting circuits 141-143; and the light-emitting circuits 141, 142 and 143 are electrically connected to the corresponding independent slave 120 or each of the dependent slaves 131 and 132 respectively. Taking FIG. 6 as an example, the light-emitting circuit 141 is electrically connected to the independent slave 120, the light-emitting circuit 142 is electrically connected to the dependent slave 131, and the light-emitting circuit 143 is electrically connected to the dependent slave 132.

In some embodiments, the light-emitting circuits 141, 142 and 143 are respectively configured to emit light according to corresponding driving signals Sd1, Sd2 and Sd3. Taking FIG. 6 as an example, the light-emitting circuit 141 emits light according to the driving signal Sd1 generated by the independent slave 120, the light-emitting circuit 142 emits light according to the driving signal Sd2 generated by the dependent slave 131, and the light-emitting circuit 143 emits light according to the driving signal Sd3 generated by the dependent slave 132. In some embodiments, the light-emitting circuits 141-143 are, for example, light-emitting diodes (LEDs), fluorescent lamps or light-emitting panels. The present disclosure is not limited thereto.

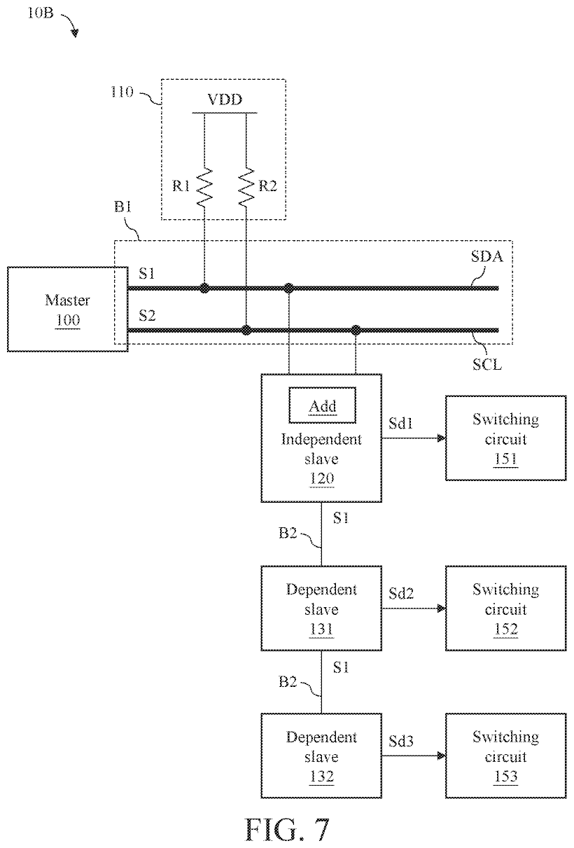

Refer to FIG. 2 and FIG. 7, FIG. 7 is a module block diagram of a master/slave system 10B according to a third embodiment. The master/slave system 10B corresponds to the master/slave system 10 in FIG. 2. In some embodiments, the master/slave system 10B further includes a plurality of switching circuits 151-153; and the switching circuits 151, 152 and 153 are electrically connected to the corresponding independent slave 120 or each of the dependent slaves 131 and 132 respectively. Taking FIG. 7 as an example, the switching circuit 151 is electrically connected to the independent slave 120, the switching circuit 152 is electrically connected to the dependent slave 131, and the switching circuit 153 is electrically connected to the dependent slave 132.

In some embodiments, the switching circuits 151, 152 and 153 are respectively switched on according to corresponding driving signals Sd1, Sd2 and Sd3. By taking FIG. 7 as an example, the switching circuit 151 is switched on according to the driving signal Sd1 generated by the independent slave 120, the switching circuit 152 is switched on according to the driving signal Sd2 generated by the dependent slave 131, and the switching circuit 153 is switched on according to the driving signal Sd3 generated by the dependent slave 132. In some embodiments, the plurality of switching circuits 151-153 are, for example, bipolar junction transistors (BJTs) or metal-oxide-semiconductor field effect transistors (MOSFETs). The present disclosure is not limited thereto.

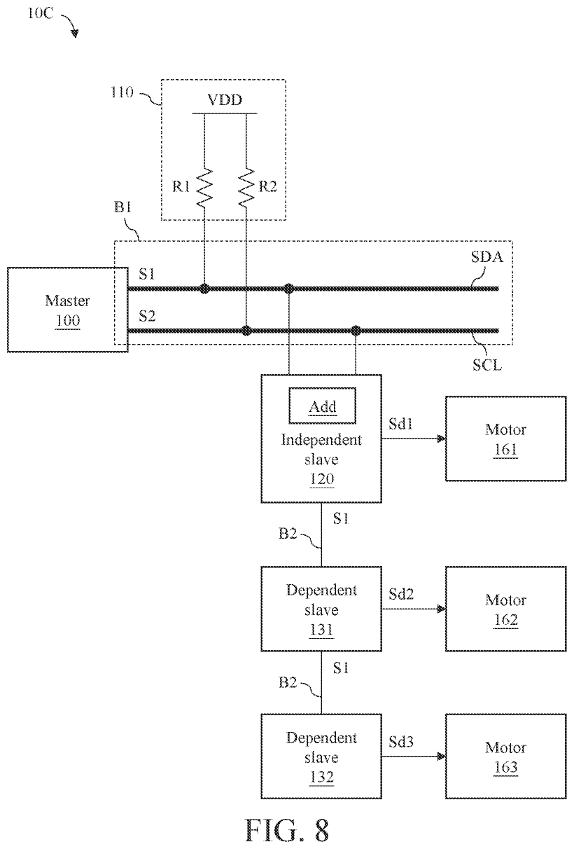

Refer to FIG. 2 and FIG. 8, FIG. 8 is a module block diagram of a master/slave system 10C according to a third embodiment. The master/slave system 10C corresponds to the master/slave system 10 in FIG. 2. In some embodiments, the master/slave system 10C further includes a plurality of motors 161-163; and the motors 161, 162 and 163 are electrically connected to the corresponding independent slave 120 or each of the dependent slaves 131 and 132 respectively. In FIG. 8, the motor 161 is electrically connected to the independent slave 120, the motor 162 is electrically connected to the dependent slave 131, and the motor 163 is electrically connected to the dependent slave 132.

In some embodiments, motors 161, 162 and 163 are respectively rotated according to corresponding driving signals Sd1, Sd2 and Sd3. In FIG. 8, the motor 161 is rotated according to the driving signal Sd1 generated by the independent slave 120, the motor 162 is rotated according to the driving signal Sd2 generated by the dependent slave 131, and the motor 163 is rotated according to the driving signal Sd3 generated by the dependent slave 132. In some embodiments, the plurality of motors 161-163 are, for example, brush motors, brushless motors or stepper motors. The present disclosure is not limited thereto.

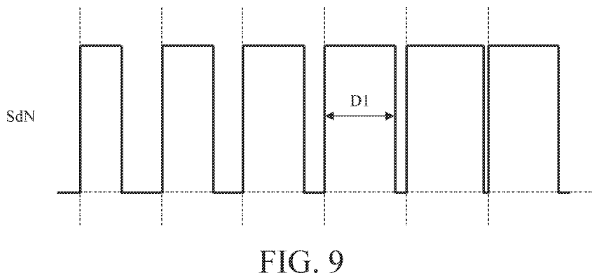

Refer to FIG. 6 to FIG. 9, FIG. 9 is a schematic diagram of a driving signal SdN according to a first embodiment. The driving signal SdN corresponds to any one of the driving signals Sd1-Sd3. In some embodiments, the driving signal Sd1 of the independent slave 120 and the driving signals Sd2-Sd3 of the plurality of dependent slaves 131-132 are pulse width modulation (PWM) signals. The PWM signals are pulse wave signals, and are characterized in that the duty cycle D1 of each pulse wave in the PWM signals are adjustable.

In some embodiments, the light-emitting time of light-emitting circuits 141-143 can be adjusted by adjusting the duty cycle D1 of the driving signals Sd1-Sd3. The longer the duty cycle D1 of the driving signal Sd1 is, the longer the light-emitting time of the light-emitting circuit 141 is; and the shorter the duty cycle D1 of the driving signal Sd1 is, the shorter the light-emitting time of the light-emitting circuit 141 is.

In some embodiments, the on time of the switching circuits 151-153 can be adjusted by adjusting the duty cycle D1 of the driving signals Sd1-Sd3. The longer the duty cycle D1 of the driving signal Sd1 is, the longer the on time of the switching circuit 151 is; and the shorter the duty cycle D1 of the driving signal Sd1 is, the shorter the on time of the switching circuit 151 is.

In some embodiments, the rotating speed of the motors 161-163 can be adjusted by adjusting the duty cycle D1 of the driving signals Sd1-Sd3. The longer the duty cycle D1 of the driving signal Sd1 is, the higher the rotating speed of the motor 161 is; and the shorter the duty cycle D1 of the driving signal Sd1 is, the lower the rotating speed of the motor 161 is.

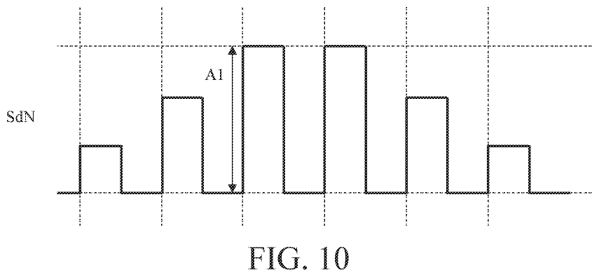

Refer to FIG. 6 to FIG. 8 and FIG. 10, FIG. 10 is a schematic diagram of a driving signal SdN according to a second embodiment. The driving signal SdN corresponds to any one of the driving signals Sd1-Sd3. In some embodiments, the driving signal Sd1 of the independent slave 120 and the driving signals Sd2-Sd3 of the plurality of dependent slaves 131-132 are pulse amplitude modulation (PAM) signals. The PAM signals are pulse wave signals, and are characterized in that the amplitude A1 of each pulse wave in the PAM signals are adjustable.

In some embodiments, the light-emitting intensity of the light-emitting circuits 141-143 can be adjusted by adjusting the amplitudes A1 of the driving signals Sd1-Sd3. The larger the amplitude A1 of the driving signal Sd1 is, the higher the light-emitting intensity of the light-emitting circuit 141 is; and the smaller the amplitude A1 of the driving signal Sd1 is, the lower the light-emitting intensity of the light-emitting circuit 141 is.

In some embodiments, the on speed of the switching circuits 151-153 can be adjusted by adjusting the amplitudes A1 of the driving signals Sd1-Sd3. The larger the amplitude A1 of the driving signal Sd1 is, the higher the on speed of the switching circuit 151 is; and the smaller the amplitude A1 of the driving signal Sd1 is, the lower the on speed of the switching circuit 151 is.

In some embodiments, the rotating speed of the motors 161-163 can be adjusted by adjusting the amplitudes A1 of the driving signals Sd1-Sd3. The larger the amplitude A1 of the driving signal Sd1 is, the higher the rotating speed of the motor 161 is; and the smaller the amplitude A1 of the driving signal Sd1 is, the lower the rotating speed of the motor 161 is.

In conclusion, according to some embodiments, the plurality of slaves (including the independent slave 120 and the plurality of dependent slaves 131-13N) connected in series with one another through the plurality of buses B2 are electrically connected to the I2C bus B1 of the master/slave system 10 to increase the quantity of the slaves which can be controlled by the master 100. Therefore, even if there can only be 128 devices on one I2C bus B1 at most, the master 100 of the master/slave system 10 can control more than 127 slaves, expanding the application field of the master/slave system 10.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A master/slave system, comprising:
a master, configured to generate a data signal and a clock signal, the data signal comprising address information and a plurality of control instructions;
an I2C bus, electrically connected to the master and comprising a data line configured to transmit the data signal, and a clock line configured to transmit the clock signal;
a power supply module, electrically connected to the I2C bus and configured to provide constant voltage power to the I2C bus, the constant voltage power is in a high potential state;
an independent slave, electrically connected to the I2C bus, provided with a device address and configured to receive the data signal and the clock signal according to the device address and the address information; and
a plurality of dependent slaves, connected in series with one another through a plurality of buses and electrically connected to the independent slave, the potential state of each bus in idle is different from that of the I2C bus in idle.

2. The master/slave system according to claim 1, wherein the power supply module comprises:
a first resistor, one end of which is electrically connected to the constant voltage power and the other end is electrically connected to the data line, the first resistor is configured to pull up the potential of the data line to reach the potential of the constant voltage power supply; and
a second resistor, one end of which is electrically connected to the constant voltage power and the other end is electrically connected to the clock line, the second resistor is configured to pull up the potential of the clock line to reach the potential of the constant voltage power supply.

3. The master/slave system according to claim 1, wherein the plurality of buses are of a double-wire structure (2-wire), and each of the buses is configured to transmit the data signal and the clock signal; each of the dependent slaves is configured to receive the data signal and the clock signal; and at least one wire of each of the buses is in a low potential state when being idle.

4. The master/slave system according to claim 1, wherein the plurality of buses are of a single-wire structure (1-wire), and each of the buses is configured to transmit the data signal; each of the dependent slaves is configured to receive the data signal; and each of the buses is in a low potential state when being idle.

5. The master/slave system according to claim 1, wherein the independent slave is further configured to generate a driving signal of the independent slave according to each corresponding control instruction; and each of the dependent slaves is further configured to generate a driving signal of each of the dependent slaves according to each corresponding control instruction.

6. The master/slave system according to claim 5, further comprising a plurality of light-emitting circuits, wherein each of the light-emitting circuits is electrically connected to the independent slave or the corresponding dependent slave.

7. The master/slave system according to claim 5, further comprising a plurality of switching circuits, wherein each of the switching circuits is electrically connected to the independent slave or the corresponding dependent slave.

8. The master/slave system according to claim 5, further comprising a plurality of motors, wherein each of the motors is electrically connected to the independent slave or the corresponding dependent slave.

9. The master/slave system according to claim 5, wherein the driving signal of the independent slave and the driving signal of each of the dependent slaves are pulse width modulation (PWM) signals.

10. The master/slave system according to claim 5, wherein the driving signal of the independent slave and the driving signal of each of the dependent slaves are pulse amplitude modulation (PAM) signals.
